(19) United States
(12) Patent Application Publication
(10) Pub. No.: US 2020/0052303 A1
(43) Pub. Date: Feb. 13, 2020

(54) SECONDARY BATTERY

(71) Applicant: Panasonic Intellectual Property Management Co., Ltd., Osaka (JP)

(72) Inventors: Takahiro Takahashi, Osaka (JP); Takahito Nakayama, Osaka (JP); Tomoki Shiozaki, Osaka (JP); Hideharu Takezawa, Nara (JP); Daisuke Furusawa, Osaka (JP); Yuji Oura, Osaka (JP)

(73) Assignee: Panasonic Intellectual Property Management Co., Ltd., Osaka (JP)

(21) Appl. No.: 16/659,770

(22) Filed: Oct. 22, 2019

Related U.S. Application Data
(63) Continuation of application No. PCT/JP2018/014188, filed on Apr. 3, 2018.

(30) Foreign Application Priority Data
Apr. 27, 2017 (JP) 2017-088752

(51) Int. Cl. H01M 4/62; H01M 4/66; H01M 4/525

(52) U.S. Cl. CPC H01M 4/628; H01M 4/667; H01M 2004/028; H01M 4/525; H01M 4/625

(57) ABSTRACT

Provided is a secondary battery comprising a positive electrode, a negative electrode, and an electrolyte. The positive electrode is provided with a positive electrode collector, a positive electrode mix layer containing positive electrode active substance particles, and an intermediate layer disposed between the positive electrode collector and positive electrode mix layer. The intermediate layer contains a conductor and a cured product of a curable resin having at least one selected from a glycidyl, hydroxy, carboxyl, amino, acryloyl, and methacryloyl groups.

### TECHNICAL FIELD

The present invention relates to the technology of a secondary battery.

### BACKGROUND ART

In recent years, as a secondary battery with high output and high energy density, a secondary battery is widely used, the battery comprising a positive electrode, a negative electrode, and an electrolyte wherein lithium ions are transferred between the positive electrode and the negative electrode to perform charge and discharge.

For example, Patent Literatures 1 to 3 disclose non-aqueous electrolyte secondary batteries comprising a positive electrode having a positive electrode current collector, a positive electrode mixture layer, and an intermediate layer disposed between the positive electrode current collector and the positive electrode mixture layer.

### CITATION LIST

### Patent Literature

PATENT LITERATURE 1: Japanese Unexamined Patent Application Publication No. 2016-127000

PATENT LITERATURE 2: Japanese Unexamined Patent Application Publication No. Hei 09-147916

PATENT LITERATURE 3: Japanese Patent Publication No. 5837884

### SUMMARY

When the adhesion performance of the intermediate layer is poor and an internal short circuit occurs in the secondary battery, the intermediate layer in the vicinity of the short-circuit portion may peel off from the positive electrode current collector together with the positive electrode mixture layer, and the positive electrode current collector may be exposed. When the positive electrode current collector is exposed, the short-circuit current between the positive and negative electrodes increases, and the battery temperature may become high.

An object of the present disclosure is to provide a secondary battery that can suppress a rise in the battery temperature when an internal short circuit occurs.

The secondary battery according to one aspect of the present disclosure has a positive electrode, a negative electrode, and an electrolyte, and the above positive electrode comprises: a positive electrode current collector; a positive electrode mixture layer including positive electrode active material particles; and an intermediate layer provided between the above positive electrode current collector and the above positive electrode mixture layer. The above intermediate layer includes: a cured product of a curable resin having at least any one of a glycidyl group, a hydroxy group, a carboxyl group, an amino group, an acryloyl group, and a methacryloyl group; and a conductive agent.

According to one aspect of the present disclosure, it is possible to suppress a rise in the battery temperature when an internal short circuit occurs.

### BRIEF DESCRIPTION OF DRAWING

FIG. 1 is a sectional view of a secondary battery as an example of the embodiment.

FIG. 2 is a sectional view of a positive electrode as an example of the embodiment.

FIG. 3 is a sectional view of a positive electrode as another example of the embodiment.

FIG. 4 is a schematic view of the apparatus used in the peel strength test of the positive electrode mixture layers in Examples and the Comparative Example.

### DESCRIPTION OF EMBODIMENTS

The positive electrode used for the secondary battery according to one aspect of the present disclosure comprises: a positive electrode current collector; a positive electrode mixture layer including positive electrode active material particles; and an intermediate layer provided between the above positive electrode current collector and the above positive electrode mixture layer, and the above intermediate layer includes: a cured product of a curable resin having at least any one of a glycidyl group, a hydroxy group, a carboxyl group, an amino group, an acryloyl group, and a methacryloyl group (hereinafter sometimes referred to as a reactive functional group); and a conductive agent. Generally, the curable resin functions as a binder, and the curable resin is cured to adhere the intermediate layer and the positive electrode current collector each other. For the cured product of the curable resin having the reactive functional group in the present disclosure, the curable resins are cross-linked each other through the reactive functional group to increase the molecular weight. Therefore, the cured product of the present disclosure has an increased contact area with the positive electrode current collector as compared with, for example, polyvinylidene fluoride generally used as a binder, thereby improving adhesive strength between the intermediate layer and the positive electrode current collector. As a result, when an internal short circuit occurs in the secondary battery, the intermediate layer in the vicinity of the short-circuit portion is difficult to peel off from the positive electrode current collector and becomes a resistance component, and hence an increase in the short-circuit current between the positive and negative electrodes is suppressed to suppress a rise in the battery temperature.

Hereinafter, an example of the embodiment will be described in detail. The drawings referred in the description of the embodiment are schematically described, and the dimensional ratio of the component drawn in the drawings may be different from the actual one.

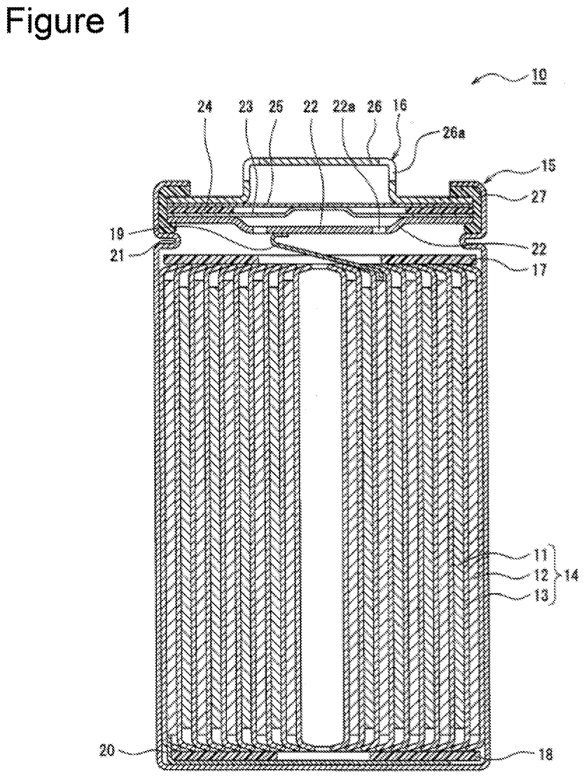

FIG. 1 is a sectional view of a secondary battery as an example of the embodiment. The secondary battery 10 shown in FIG. 1 comprises: a wound type electrode assembly 14 obtained by winding a positive electrode 11 and a negative electrode 12 together with a separator 13 therebetween; an electrolyte; insulating plates 17 and 18 respectively disposed above and below the electrode assembly 14; and a battery case for housing the above members. The battery case is composed of a case main body 15 having a bottomed cylindrical shape and a sealing body 16. Instead of the wound type electrode assembly 14, another form of an electrode assembly may be applied, such as a stacked electrode assembly in which the positive electrode and the negative electrode are alternately stacked through the separator. Examples of the battery case include a metallic case such as a cylindrical shape, a square shape, a coin shape, or a button shape and a resin case (laminated battery) formed by laminating a resin sheet.

The case main body 15 is, for example, a metallic container with a bottomed cylindrical shape. A gasket 27 is provided between the case main body 15 and the sealing body 16 to ensure the sealability inside the battery case. The case main body 15 preferably has the projecting portion 21, which is formed, for example, by pressing the side surface portion from the outside, for supporting the sealing body 16. The projecting portion 21 is preferably formed in an annular shape along the circumferential direction of the case main body 15, and the sealing body 16 is supported on the upper surface thereof.

The sealing body 16 has a filter 22 in which a filter opening 22a is formed, and a valve body disposed on the filter 22. The valve body closes the filter opening 22a of the filter 22, and breaks when the internal pressure of the battery rises by heat generation due to an internal short circuit or the like. In the present embodiment, a lower valve body 23 and an upper valve body 25 are provided as valve bodies, and an insulating member 24 disposed between the lower valve body 23 and the upper valve body 25 and a cap 26 having a cap opening 26a are further provided. Each member constituting the sealing body 16 has a disk shape or a ring shape, for example, and each member except the insulating member 24 is electrically connected each other. Specifically, the filter 22 and the lower valve body 23 are joined together at their respective peripheral portions, and the upper valve body 25 and the cap 26 are also joined together at their respective peripheral portions. The lower valve body 23 and the upper valve body 25 are connected together at their respective central portions, and the insulating member 24 is interposed between the respective peripheral portions. When the internal pressure rises by heat generation due to an internal short circuit or the like, for example, the lower valve body 23 is broken at its thin portion, and thereby the upper valve body 25 bulges to the cap 26 side and leaves the lower valve body 23 to block both electrical connections.

In the secondary battery 10 shown in FIG. 1, a positive electrode lead 19 attached to the positive electrode 11 extends to the side of the sealing body 16 through the through hole of the insulating plate 17, and a negative electrode lead 20 attached to the negative electrode 12 extends to the bottom side of the case main body 15 through the outside of the insulating plate 18. For example, the positive electrode lead 19 is connected to the lower surface of the filter 22, which is a bottom plate of the sealing body 16, by welding or the like, and the cap 26, which is a top plate of the sealing body 16 electrically connected to the filter 22, serves as a positive electrode terminal. The negative electrode lead 20 is connected to the inner surface of bottom of the case main body 15, by welding or the like, and the case main body 15 serves as a negative electrode terminal.

[Positive Electrode]

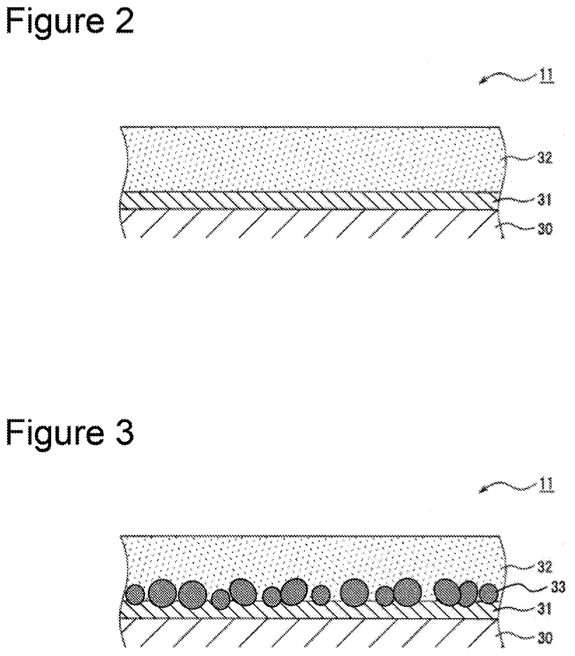

FIG. 2 is a sectional view of a positive electrode as an example of the embodiment. The positive electrode 11 comprises a positive electrode current collector 30, a positive electrode mixture layer 32, and an intermediate layer 31 provided between the positive electrode current collector 30 and the positive electrode mixture layer 32.

As the positive electrode current collector 30, a foil of a metal stable in the potential range of the positive electrode such as aluminum or an aluminum alloy, a film in which the metal is disposed on an outer layer, or the like can be used. The positive electrode current collector 30 has, for example, a thickness of about 10 μm to 100 μm.

The positive electrode mixture layer 32 includes positive electrode active material particles. The positive electrode mixture layer 32 preferably includes a binder, from the viewpoints such that positive electrode active material particles can be bound each other to ensure the mechanical strength of the positive electrode mixture layer 32 and the bonding property between the positive electrode mixture layer 32 and the intermediate layer 31 can be enhanced. The positive electrode mixture layer 32 preferably includes a conductive agent from the viewpoint such that the conductivity of the layer can be improved.

Examples of positive electrode active material particles include lithium transition metal oxide particles containing transition metal elements such as Co, Mn, and Ni. Examples of lithium transition metal oxide particles include LiₓCoO₂, LiₓNiO₂, LiₓMnO₂, LiₓCo_{y}Ni_{1-y}O₂, LiₓCo_{y}M_{1-y}O_{z}, LiₓNi_{1-y}M_{y}O₄, LiₓMn₂O₄, LiₓMn_{2-y}M_{y}O₄, LiMPO₄, and Li₂MPO₄F (M: at least one of Na, Mg, Sc, Y, Mn, Fe, Co, Ni, Cu, Zn, Al, Cr, Pb, Sb, and B, 0<x≤1.2, 0<y≤0.9, and 2.0≤z≤2.3). These may be used singly or as a mixture of two or more. From the viewpoint of increasing the capacity of the secondary battery, positive electrode active material particles preferably include lithium nickel composite oxide particles such as LiₓNiO₂, LiₓCO_{y}Ni_{1-y}O₂, and LiₓNi_{1-y}M_{y}O_{z} (M: at least one of Na, Mg, Sc, Y, Mn, Fe, Co, Ni, Cu, Zn, Al, Cr, Pb, Sb, and B, 0<x≤1.2, 0<y≤0.9, and 2.0≤z≤2.3).

Examples of the conductive agent include carbon particles such as carbon black (CB), acetylene black (AB), ketjen black, and graphite. These may be used singly or in combination of two or more.

Examples of the binder include fluorine resins such as polytetrafluoroethylene (PTFE) and polyvinylidene fluoride (PVdF), polyacrylonitrile (PAN), polyimide resins, acrylic resins, and polyolefin resins. These resins may be used in combination with carboxymethylcellulose (CMC) or a salt thereof (CMC-Na, CMC-K, CMC-NH₄, or the like, or a partially neutralized salt may be used), polyethylene oxide (PEO), and the like. These may be used singly or in combination of two or more.

The intermediate layer 31 includes a cured product of the curable resin having the above reactive functional group and a conductive agent. As described above, since the cured product of the curable resin having the above reactive functional group improves the adhesiveness between the intermediate layer 31 and the positive electrode current collector 30, peeling of the intermediate layer 31 in the vicinity of the short-circuit portion from the positive electrode current collector 30 is suppressed in the such case that an internal short circuit occurs due to conductive foreign matter. The conductive agent in the intermediate layer 31 ensures the electrical conduction between the positive electrode mixture layer 32 and the positive electrode current collector 30 through the intermediate layer 31 in the normal case where no internal short circuit occurs.

The curable resin having the above reactive functional group is a thermosetting resin that is cured by heating and then exhibits electrical insulation properties or a photocurable resin that is cured by irradiation with high energy rays such as ultraviolet rays, visible rays, electron beams, and X-rays, and then exhibits electrical insulation properties.

Examples of the thermosetting resin having the above reactive functional group include a glycidyl group-containing acrylic copolymer, a glycidyl group-containing epoxy resin, a hydroxy group-containing acrylic resin, a carboxyl group-containing acrylic resin, an amino group-containing acrylic resin, an acryloyl group-containing acrylic resin, and a methacryloyl group-containing acrylic resin.

Examples of the glycidyl group-containing acrylic copolymer include those obtained by copolymerizing one or more glycidyl group-containing monomers selected from glycidyl methacrylate, glycidyl acrylate, β-methyl glycidyl methacrylate, and β-methyl glycidyl acrylate with polymerizable monomers such as styrene, vinyl toluene, methyl methacrylate, n-butyl methacrylate, i-butyl methacrylate, n-butyl acrylate, cyclohexyl methacrylate, vinyl acetate, vinyl cyclohexanecarboxylate, dibutyl fumarate, diethyl fumarate, and N-dimethylacrylamide.

Examples of the glycidyl group-containing epoxy resin include bisphenol epoxy resins such as bisphenol A epoxy resins and bisphenol F epoxy resins; novolac epoxy resins such as naphthalene-containing novolac epoxy resins, trisphenol methane epoxy resins, tetrakisphenol ethane epoxy resins, dicyclopentadiene epoxy resins, and phenol biphenyl epoxy resins; biphenyl epoxy resins such as tetramethylbiphenyl epoxy resins;

polycyclic aromatic epoxy resins such as epoxy resins having naphthalene structure, epoxy resins having anthracene structure, or epoxy resins having pyrene structure; hydrogenated alicyclic epoxy resins such as hydrogenated bisphenol A epoxy resins; and mesogenic skeleton epoxy resins such as terephthalylidene epoxy resins having mesogenic groups as a skeleton.

Examples of the hydroxy group-containing acrylic resin include acrylic resins including self-crosslinked products such as β-hydroxyethyl vinyl ether and 5-hydroxypentyl vinyl ether.

Examples of the carboxyl group-containing acrylic resin include acrylic resins including acrylic acid, methacrylic acid, and itaconic acid.

Examples of the amino group-containing acrylic resin include polymers such as acrylic (or methacrylic) amide, 2-aminoethyl vinyl ether, N-methylol acryloamide, ureido vinyl ether, and ureido ethyl acrylate.

Examples of the acryloyl group-containing acrylic resin include acrylic resins obtained by using the main monomer such as N-butyl acrylate, isobutyl acrylate, s-butyl acrylate, t-butyl acrylate, pentyl acrylate, isopentyl acrylate, hexyl acrylate, heptyl acrylate, octyl acrylate, 2-ethylhexyl acrylate, isooctyl acrylate, nonyl acrylate, isononyl acrylate, decyl acrylate, isodecyl acrylate, undecyl acrylate, dodecyl acrylate, tridecyl acrylate, tetradecyl acrylate, pentadecyl acrylate, hexadecyl acrylate, heptadecyl acrylate, octadecyl acrylate, nonadecyl acrylate, and eicosyl acrylate.

Examples of methacryloyl group-containing acrylic resin include acrylic resins obtained by using the main monomer such as N-butyl methacrylate, isobutyl methacrylate, s-butyl methacrylate, t-butyl methacrylate, pentyl methacrylate, isopentyl methacrylate, hexyl methacrylate, heptyl methacrylate, octyl methacrylate, 2-ethylhexyl methacrylate, isooctyl methacrylate, nonyl methacrylate, isononyl methacrylate, decyl methacrylate, isodecyl methacrylate, undecyl methacrylate, dodecyl methacrylate, tridecyl methacrylate, tetradecyl methacrylate, pentadecyl methacrylate, hexadecyl methacrylate, heptadecyl methacrylate, octadecyl methacrylate, nonadecyl methacrylate, and eicosyl methacrylate.

Examples of the photocurable resin having the above reactive functional group include those obtained by mixing lauryl acrylate/acrylic acid copolymers with acrylic polyfunctional monomers (or oligomers) such as polyoxazoline, polyisocyanate, a melamine resin, polycarbodiimide, polyol, and polyamine and copolymerizing them by ultraviolet irradiation or electron beam irradiation (heating as required).

Among the above examples, the curable resin having a glycidyl group such as a glycidyl group-containing acrylic copolymer and a glycidyl group-containing epoxy resin is preferred, from the viewpoint that the adhesiveness between the intermediate layer 31 and the positive electrode current collector 30 can be further improved.

The content of the cured product of the curable resin having the above reactive functional group is preferably, for example, in the range of 10 mass % or more and 90 mass % or less, and more preferably in the range of 20 mass % or more and 70 mass % or less, with respect to the total amount of the intermediate layer 31. The content of the cured product satisfies the above range, allowing the adhesiveness between the intermediate layer 31 and the positive electrode current collector 30 to be further improved.

The curing degree of the cured product of the curable resin having the above reactive functional group may be 100% (fully cured), and is preferably 30% or more and 90% or less and more preferably 40% or more and 85% or less. When the cured product is in a semi-cured state (less than 100%), the cured product in the intermediate layer 31 is softened by heat during internal short circuit and then re-cured (the curing degree rises). A cured product having a curing degree of 90% or less tends to be more softened by heat during internal short circuit as compared with a cured product having a curing degree of more than 90%. For example, if an internal short circuit occurs due to conductive foreign matter and then the conductive foreign material moves for some reason, new short-circuit points may be generated to continue the internal short circuit, but when the cured product having a curing degree of 90% or less exists in the intermediate layer 31, the above cured product softened by the internal short circuit flows between the conductive foreign material and the positive electrode current collector and is then re-cured, thereby suppressing the generation of new short-circuit points. In addition, a cured product having a curing degree of 30% or more exhibits a higher adhesive strength than a cured product having a curing degree of less than 30%, and hence the adhesiveness of the intermediate layer 31 may be improved. The curing degree of the cured product of the curable resin in the intermediate layer is adjusted by a curing time, a curing temperature, and the like when the curable resin having a reactive functional group is cured. The method for measuring the curing degree is described in the following Examples.

Examples of the conductive agent included in the intermediate layer 31 includes the same kind of the conductive agent applied to the positive electrode mixture layer 32, for example, carbon particles such as carbon black (CB), acetylene black (AB), ketjen black, and graphite; conductive metal oxide particles such as antimony-doped tin oxide; metal particles such as aluminum and copper; and an inorganic filler coated with metal. These may be used singly or in combination of two or more. The conductive agent preferably includes carbon particles from the viewpoints such as the conductivity of the intermediate layer 31 and the manufacturing cost.

The content of the conductive agent is preferably, for example, 1 mass % or more and 100 mass % or less in the cured product of the curable resin having a reactive functional group. The content of the conductive agent satisfies the above range, which may improve the electrical conduction between the positive electrode mixture layer 32 and the positive electrode current collector 30 through the intermediate layer 31 in the normal case where no internal short circuit occurs and may improve output characteristics.

The intermediate layer 31 preferably includes an insulating inorganic material. For example, when an internal short circuit occurs due to conductive foreign matter, the insulating inorganic material is included in the intermediate layer 31, allowing the insulating inorganic material in the intermediate layer 31 to be a resistance component, further suppressing the increase in short-circuit current between the positive and negative electrodes, and further suppressing a rise in the battery temperature.

When the insulating inorganic material is included in the intermediate layer 31, the content of the conductive agent can be reduced. On the other hand, when the insulating inorganic material is not included in the intermediate layer 31, in order to ensure the conductivity of the intermediate layer 31, it is desirable to increase the content of the conductive agent. Generally, dispersibility of the conductive agent is high and thus it is preferable to contain a large amount of the conductive agent from the viewpoint of ensuring the conductivity of the intermediate layer 31, on the other hand, in the case where the insulating inorganic material is included, the inorganic material interferes with the dispersibility of the conductive agent, allowing to ensure the sufficient conductivity of the intermediate layer 31 even in a small content of the conductive agent. As described above, the content of the conductive agent is preferably 1 mass % or more and 100 mass % or less in the cured product of the curable resin having a reactive functional group; particularly the content of the conductive agent in the case where the insulating inorganic material is not included in the intermediate layer 31 is preferably 30 mass % or more and 100 mass % or less in the cured product of the curable resin having a reactive functional group and more preferably 40 mass % or more and 80 mass % or less; and particularly the content of the conductive agent in the case where the insulating inorganic material is included in the intermediate layer 31 is preferably 1 mass % or more and 99 mass % or less in the cured product of the curable resin having a reactive functional group and more preferably 3 mass % or more and 75 mass % or less.

The insulating inorganic material is preferably, for example, an inorganic material having a resistivity of 10¹² Ωcm or more, and examples thereof include metal oxides, metal nitrides, and metal fluorides. Examples of the metal oxide include aluminum oxide, titanium oxide, zirconium oxide, silicon oxide, manganese oxide, magnesium oxide, and nickel oxide. Examples of the metal nitride include boron nitride, aluminum nitride, magnesium nitride, and silicon nitride. Examples of the metal fluoride include aluminum fluoride, lithium fluoride, sodium fluoride, magnesium fluoride, calcium fluoride, barium fluoride, aluminum hydroxide, and boehmite. The insulating inorganic material preferably includes at least any one of aluminum oxide, titanium oxide, silicon oxide, and manganese oxide, and more preferably includes at least aluminum oxide, from the viewpoints such as an insulating property, a high melting point, and lower oxidizing power than a positive electrode active material. When an internal short circuit occurs, the redox reaction between positive electrode active material particles and the positive electrode current collector 30 (especially the positive electrode current collector of aluminum or an aluminum alloy) may generate heat, but the above redox reaction can be suppressed by using the insulating inorganic material having lower oxidizing power than the positive electrode active material, and thus a rise in the battery temperature can be suppressed.

The content of the insulating inorganic material in the intermediate layer 31 is preferably in the range of 1 mass % or more and 100 mass % or less in the cured product of the curable resin having a reactive functional group, and more preferably in the range of 5 mass % or more and 90 mass % or less. The content of a sum of the conductive agent and the insulating inorganic material in the intermediate layer 31 is preferably 25 mass % or more and 100 mass % or less in the cured product of the curable resin having a reactive functional group, and more preferably 40 mass % or more and 80 mass % or less. The mass ratio of the insulating inorganic material and the conductive agent in the intermediate layer 31 (insulating inorganic material:conductive agent) is preferably in the range of 1:0.05 to 1:70, and more preferably in the range of 1:0.1 to 1:30. The contents of the insulating inorganic material and the conductive agent set in the above ranges allow for more effective suppression of a rise in the battery temperature due to an internal short circuit. Since the curable resin has an insulating property, the content of the insulating inorganic material may be small from the viewpoint of the insulating property.

The intermediate layer 31 may include other resins other than the curable resin having the above reactive functional group. Examples of other resins include fluorine resins such as polytetrafluoroethylene (PTFE) and polyvinylidene fluoride (PVdF). Including other resins other than the curable resin can adjust the hardness of the intermediate layer 31. Thereby, the stress in winding an electrode can be adjusted. The mass ratio of the curable resin having the above reactive functional group and the fluorine resins in the intermediate layer 31 (curable resin:fluorine resin) is preferably in the range of 1:1 to 1:10, and more preferably in the range of 1:5 to 1:10.

The thickness of the intermediate layer 31 is, for example, preferably in the range of 0.5 μm or more and 10 μm or less, and more preferably 1 μm or more and 5 μm or less. When the thickness of the intermediate layer 31 is less than 0.5 μm, the battery temperature due to an internal short circuit may be higher as compared with the case where the thickness satisfies the above range. The thickness of the intermediate layer 31 exceeds 10 μm, which may increase the resistance between the positive electrode mixture layer 32 and the positive electrode current collector 30 in the normal case where no internal short circuit occurs to deteriorate the output characteristics of the battery, as compared with the case where the thickness satisfies the above range.

An example of a method for producing the positive electrode 11 will be described. On the positive electrode current collector 30, a slurry for the intermediate layer including the curable resin having the above reactive functional group, the conductive agent, and the like is applied; the resulting coating is heated (and irradiated with high energy rays); and the curable resin having the reactive functional group is cured to form the intermediate layer 31 including the cured product of the curable resin, the conductive agent, and the like. Then, on the intermediate layer 31, a positive electrode mixture slurry including positive electrode active material particles and the like is applied and dried to form the positive electrode mixture layer 32, and the positive electrode mixture layer 32 is rolled. The positive electrode 11 is obtained as described above.

The curing degree of the cured product in the intermediate layer 31 is adjusted by the heating time, the time during high energy ray irradiation, the curing temperature (heating temperature), and the like when the curable resin is cured. The curing temperature and curing time when the curing degree of the cured product of the curable resin is 30% or more and 60% or less depend on the curable resin to be used, and are desirable to be, for example, in the range of 80° C. to 110° C. and in the range of 20 minutes to 40 minutes, respectively. The curing degree of the cured product in the intermediate layer 31 may be adjusted when the slurry for the intermediate layer is applied, or may be adjusted when the positive electrode mixture slurry is applied.

FIG. 3 is a sectional view of a positive electrode as another example of the embodiment. The positive electrode 11 shown in FIG. 3 comprises the positive electrode current collector 30, the positive electrode mixture layer 32 including positive electrode active material particles 33, and the intermediate layer 31 provided between the positive electrode current collector 30 and the positive electrode mixture layer 32, and at least some of the positive electrode active material particles 33 of the positive electrode mixture layer 32 have at least a part that extends into the intermediate layer 31 after entering there. That is, parts of the positive electrode mixture layer 32 extend into the intermediate layer 31 after entering there. In FIG. 3, only the positive electrode active material particles 33 present in the intermediate layer 31 after entering there are shown; however, the positive electrode active material particles 33 are dispersed throughout the positive electrode mixture layer 32.

Thus, a part of the positive electrode active material particles 33 is present in the intermediate layer 31 after entering there, increasing the contact area between the positive electrode mixture layer 32 and the intermediate layer 31 and improving the adhesive strength between the positive electrode mixture layer 32 and the intermediate layer 31. As a result, when an internal short circuit occurs in the secondary battery, the positive electrode mixture layer 32 in the vicinity of the short-circuited portion is hardly peeled off from the intermediate layer 31, and hence the positive electrode mixture layer 32 also contributes as a resistance component, the increase in the short-circuit current between the positive and negative electrodes is suppressed, and a rise in the battery temperature is further suppressed.

The positive electrode active material particles 33 are preferably present inside of the intermediate layer 31 by 5% or more of the thickness of the intermediate layer 31 from the surface on the positive electrode mixture layer side. In other words, the positive electrode active material particles 33 are preferably present inside of the intermediate layer 31 by 0.5 μm or more from the surface on the positive electrode mixture layer side. Satisfying the above range improves the adhesive strength between the intermediate layer 31 and the positive electrode mixture layer 32 as compared with the case where the above range is not satisfied.

Examples of a method for causing the positive electrode active material particles 33 to enter the intermediate layer 31 include a method in which the positive electrode mixture slurry is applied to the intermediate layer 31 including a cured product in the semi-cured state, dried, and then rolled. There is a method in which the positive electrode mixture slurry is applied to the intermediate layer 31 including a cured product in the completely cured state, dried, and then rolled, and this method also can cause the positive electrode active material particles 33 to enter the intermediate layer 31, but in this case, the pressure applied during rolling is required to be higher.

[Negative Electrode]

The negative electrode 12 comprises, for example, the negative electrode current collector, such as the metal foil, and the negative electrode mixture layer formed on the negative electrode current collector. As the negative electrode current collector, a foil of a metal stable in the potential range of the negative electrode such as copper, the film in which the metal is disposed on an outer layer, or the like can be used. The negative electrode mixture layer includes the negative electrode active material, the binder, and the thickener.

The negative electrode 12 is obtained, for example, by applying and drying the negative electrode mixture slurry including the negative electrode active material, the thickener, and the binder on the negative electrode current collector to form the negative electrode mixture layer on the negative electrode current collector and by rolling the negative electrode mixture layer. The negative electrode mixture layer may be provided on the both surfaces of the negative electrode current collector.

The negative electrode active material is not particularly limited as long as it is a material capable of absorbing and desorbing lithium ions, and examples thereof include lithium alloys such as a metallic lithium, a lithium-aluminum alloy, a lithium-lead alloy, a lithium-silicon alloy, and a lithium-tin alloy; carbon materials such as graphite, coke, and an organic sintered body; and metal oxides such as SnO₂, SnO, and TiO₂. These may be used singly or in combination of two or more.

As the binder included in the negative electrode mixture layer, a fluorine resin, PAN, a polyimide resin, an acrylic resin, a polyolefin resin, or the like can be used as in the case of the positive electrode. When the negative electrode mixture slurry is prepared by using an aqueous solvent, styrene-butadiene rubber (SBR), CMC or a salt thereof, polyacrylic acid (PAA) or a salt thereof (which is PAA-Na, PAA-K, or the like, or may be partially neutralized salt), polyvinyl alcohol (PVA), or the like is preferably used.

[Separator]

An ion-permeable and insulating porous sheet or the like is used as the separator 13. Specific examples of the porous sheet include a microporous thin film, a woven fabric, and a nonwoven fabric. Suitable examples of the material for the separator include olefin resins such as polyethylene and polypropylene, and cellulose. The separator 13 may be a laminate having a cellulose fiber layer and a layer of fibers of a thermoplastic resin such as an olefin resin. The separator 13 may also be a multi-layered separator including a polyethylene layer and a polypropylene layer, and a separator coated with a material such as an aramid resin or a ceramic on the surface thereof may be used.

[Electrolyte]

The electrolyte includes a solvent and an electrolyte salt dissolved in the solvent. The electrolyte is not limited to a liquid electrolyte (non-aqueous electrolyte solution), and may be a solid electrolyte using a gel-like polymer or the like. As a solvent, a non-aqueous solvent such as an ester, an ether, a nitrile such as acetonitrile, an amide such as dimethylformamide, or a mixed solvent of two or more of these, or water can be used. The non-aqueous solvent may contain a halogen substituted product in which at least some hydrogens of any of these solvents are replaced by a halogen atom such as fluorine.

Examples of the above esters include cyclic carbonate esters such as ethylene carbonate (EC), propylene carbonate (PC), and butylene carbonate; chain carbonate esters such as dimethyl carbonate (DMC), methyl ethyl carbonate (EMC), diethyl carbonate (DEC), methyl propyl carbonate, ethyl propyl carbonate, and methyl isopropyl carbonate; cyclic carboxylic acid esters such as γ-butyrolactone and γ-valerolactone; and chain carboxylic acid esters such as methyl acetate, ethyl acetate, propyl acetate, methyl propionate (MP), ethyl propionate, and γ-butyrolactone.

Examples of the above ethers include cyclic ethers such as 1,3-dioxolane, 4-methyl-1,3-dioxolane, tetrahydrofuran, 2-methyltetrahydrofuran, propylene oxide, 1,2-butylene oxide, 1,3-dioxane, 1,4-dioxane, 1,3,5-trioxane, furan, 2-methyl furan, 1,8-cineole, and crown ether; and chain ethers such as 1,2-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butyl phenyl ether, pentyl phenyl ether, methoxy toluene, benzyl ethyl ether, diphenyl ether, dibenzyl ether, o-dimethoxybenzene, 1,2-diethoxyethane, 1,2-dibutoxyethane, diethylene glycol dimethyl ether, diethylene glycol diethyl ether, diethylene glycol dibutyl ether, 1,1-dimethoxymethane, 1,1-diethoxyethane, triethylene glycol dimethyl ether, and tetraethylene glycol dimethyl.

As the above halogen substituted product, fluorinated cyclic carbonate esters such as fluoroethylene carbonate (FEC); fluorinated chain carbonate esters; fluorinated chain carboxylic acid esters such as methyl fluoropropionate (FMP); or the like are preferably used.

The electrolyte salt is preferably a lithium salt. Examples of the lithium salt include LiBF₄, LiClO₄, LiPF₆, LiAsF₆, LiSbF₆, LiAlCl₄, LiSCN, LiCF₃SO₃, LiCF₃CO₂, Li(P(C₂O₄)F₄), LiPF₆₋ₓ(CₙF₂ₙ₊₁)ₓ (1<x<6, n is 1 or 2), LiB₁₀Cl₁₀, LiCl, LiBr, LiI, chloroborane lithium, lower aliphatic carboxylic acid lithium, Li₂B₄O₇, borates such as Li(B(C₂O₄)F₂), and imide salts such as LiN(SO₂CF₃)₂, LiN (ClF₂ₗ₊₁SO₂)(CₘF₂ₘ₊₁SO₂) (l and m are an integer of 1 or more). For the lithium salt, these may be used singly or a mixture of various lithium salts may be used. Among them, LiPF₆ is preferably used from the viewpoints such as ion conductivity and electrochemical stability. The concentration of the lithium salt is preferably 0.8 to 1.8 mol per liter of a solvent.

### EXAMPLES

Hereinafter, the present disclosure will be described in more detail with reference to Examples, but the present disclosure is not limited to the following Examples.

### Example 1

[Production of Positive Electrode]

10 parts by mass of aluminum oxide (Al₂O₃), 50 parts by mass of acetylene black (AB), and 40 parts by mass of a glycidyl group-containing acrylic polymer (a copolymer of glycidyl methacrylate and t-butyl acrylate) were mixed and an appropriate amount of N-methyl-2-pyrrolidone (NMP) was further added to prepare a slurry for the intermediate layer. The slurry was applied to both surfaces of the positive electrode current collector consisting of an aluminum foil having a thickness of 15 μm and heated at 200° C. for 2 hours to form an intermediate layer having a thickness of 5.0 μm.

As the positive electrode active material, a lithium nickel composite oxide represented by LiNi_{0.82}Co_{0.15}Al_{0.03}O₂ was used. 97 parts by mass of the positive electrode active material, 1.5 parts by mass of acetylene black (AB), and 1.5 parts by mass of polyvinylidene fluoride (PVDF) were mixed, and then an appropriate amount of N-methyl-2-pyrrolidone (NMP) was added to prepare a positive electrode mixture slurry. This positive electrode mixture slurry was applied on the intermediate layer formed on both surfaces of the positive electrode current collector. The resulting coating was dried and rolled using a pressure roller to produce a positive electrode consisting of the positive electrode current collector, the intermediate layer formed on both surfaces of the positive electrode current collector, and the positive electrode mixture layer formed on the intermediate layer.

<Measurement of Curing Degree>

10 mg of the intermediate layer was cut out from the positive electrode, and a measurement was performed using a differential scanning calorimeter (DSC8230 Thermo Plus, manufactured by Rigaku Corporation) at a heating rate of 10° C./min from 25° C. to 200° C. in a nitrogen gas atmosphere, and the obtained heat generation curve determined a calorific value ratio of 100° C. to 170° C. The curing degree was calculated from the above calorific value ratio by using a previously drawn calibration line which indicated the curing degree with respect to the calorific value ratio. This was defined as the curing degree of the cured product of the thermosetting resin (glycidyl group-containing acrylic polymer) in the intermediate layer. The calibration line was drawn as follows. A calorific value ratio of 100° C. to 170° C. of the thermosetting resin that has been completely cured (curing degree of 100%) is defined as 0. A calorific value ratio of 100° C. to 170° C. of the thermosetting resin before curing (curing degree of 0%) is measured. The calibration line is defined as a straight line connecting the calorific value ratio with a curing degree of 0% and the calorific value ratio with a curing degree of 100%.

The curing degree, obtained by the above measurement method, of the cured product of the thermosetting resin in the intermediate layer was 100%.

[Production of Negative Electrode]

100 parts by mass of artificial graphite, 1 part by mass of carboxymethylcellulose (CMC), and 1 part by mass of styrene-butadiene rubber (SBR) were mixed to prepare a negative electrode mixture slurry. Then, the negative electrode mixture slurry was applied to both surfaces of the negative electrode current collector consisting of copper foil. The resulting coating was dried and then rolled using a pressure roller to produce a negative electrode in which a negative electrode mixture layer was formed on both surfaces of the positive electrode current collector.

[Preparation of Electrolyte]

Ethylene carbonate (EC), methyl ethyl carbonate (EMC), and dimethyl carbonate (DMC) were mixed in a volume ratio of 3:3:4. LiPF₆ was dissolved in the mixed solvent so as to obtain a concentration of 1.2 mol/L to prepare a non-aqueous electrolyte.

[Production of Secondary Battery]

Each of the above positive electrode and the negative electrode was cut into a predetermined size, attached with an electrode tab, and wound through the separator to produce a wound type electrode assembly. Then, the electrode assembly was housed in an aluminum laminate film, and the non-aqueous electrolyte was injected and sealed. This was a non-aqueous electrolyte secondary battery in Example 1.

### Example 2

A positive electrode was produced in the same manner as in Example 1 except that aluminum oxide was not added in the preparation of the slurry for the intermediate layer. The curing degree of the cured product of the thermosetting resin in the intermediate layer in Example 2 was 100%. Using this as the positive electrode in Example 2, a non-aqueous electrolyte secondary battery was produced in the same manner as in Example 1.

### Example 3

A positive electrode was produced in the same manner as in Example 1, except that aluminum oxide was not added in the preparation of the slurry for the intermediate layer, and the slurry for the intermediate layer was applied to both surfaces of the positive electrode current collector consisting of aluminum foil and heated at 100° C. for 30 minutes. The curing degree of the cured product of the thermosetting resin in the intermediate layer in Example 3 was 50%. Using this as the positive electrode in Example 3, a non-aqueous electrolyte secondary battery was produced in the same manner as in Example 1.

### Example 4

A positive electrode was produced in the same manner as in Example 1, except that in the preparation of the slurry for the intermediate layer, bisphenol A epoxy resin was used as a thermosetting resin and aluminum oxide was not added. The curing degree of the cured product of the thermosetting resin in the intermediate layer in Example 4 was 100%. Using this as the positive electrode in Example 4, a non-aqueous electrolyte secondary battery was produced in the same manner as in Example 1.

### Example 5

A positive electrode was produced in the same manner as in Example 1, except that in the preparation of the slurry for the intermediate layer, a hydroxy group-containing acrylic resin was used as a thermosetting resin and aluminum oxide was not added. The curing degree of the cured product of the thermosetting resin in the intermediate layer in Example 5 was 100%. Using this as the positive electrode in Example 5, a non-aqueous electrolyte secondary battery was produced in the same manner as in Example 1.

### Example 6

A positive electrode was produced in the same manner as in Example 1, except that in the preparation of the slurry for the intermediate layer, a carboxyl group-containing acrylic resin was used as a thermosetting resin and aluminum oxide was not added. The curing degree of the cured product of the thermosetting resin in the intermediate layer in Example 6 was 100%. Using this as the positive electrode in Example 6, a non-aqueous electrolyte secondary battery was produced in the same manner as in Example 1.

### Example 7

A positive electrode was produced in the same manner as in Example 1, except that in the preparation of the slurry for the intermediate layer, an amino group-containing acrylic resin was used as a thermosetting resin and aluminum oxide was not added. The curing degree of the cured product of the thermosetting resin in the intermediate layer in Example 7 was 100%. Using this as the positive electrode in Example 7, a non-aqueous electrolyte secondary battery was produced in the same manner as in Example 1.

### Example 8

A positive electrode was produced in the same manner as in Example 1, except that in the preparation of the slurry for the intermediate layer, an acryloyl group-containing acrylic resin was used as a thermosetting resin and aluminum oxide was not added. The curing degree of the cured product of the thermosetting resin in the intermediate layer in Example 8 was 100%. Using this as the positive electrode in Example 8, a non-aqueous electrolyte secondary battery was produced in the same manner as in Example 1.

### Example 9

A positive electrode was produced in the same manner as in Example 1, except that in the preparation of the slurry for the intermediate layer, a methacryloyl group-containing acrylic resin was used as a thermosetting resin and aluminum oxide was not added. The curing degree of the cured product of the thermosetting resin in the intermediate layer in Example 9 was 100%. Using this as the positive electrode in Example 9, a non-aqueous electrolyte secondary battery was produced in the same manner as in Example 1.

### COMPARATIVE EXAMPLE

A positive electrode was produced in the same manner as in Example 1, except that in the preparation of the slurry for the intermediate layer, a glycidyl group-containing acrylic polymer was replaced with polyvinylidene fluoride (PVDF). Using this as the positive electrode in Comparative Example, a non-aqueous electrolyte secondary battery was produced in the same manner as in Example 1.

[Nailing Test]

For the non-aqueous electrolyte secondary battery of each of Examples and Comparative Example, the nailing test was performed in the following procedure. (1) Charging was performed until the battery voltage reached 4.2 V at a constant current of 600 mA under an environment of 25° C., and then charging was continued until the current value reached 90 mA at a constant voltage. (2) Under an environment of 25° C., the tip of a round nail having a 2.7 mmϕ diameter was contact with the center portion in the side surface of the battery charged in (1), the round nail pierced thereto in the stacking direction of the electrode assembly in the battery at a rate of 1 mm/s, and the round nail was stopped to pierce immediately after a battery voltage drop due to an internal short circuit was detected. (3) The battery surface temperature was measured in 1 minute passed after the battery started a short circuit with the round nail. (4) After the battery temperature was measured, the round nail was moved for 0.5 seconds in the stacking direction of the electrode assembly in the battery at a rate of 0.1 mm/s to confirm the presence or absence of a voltage drop. When the voltage drop occurred, the nail and the electrode were determined to be in contact with each other again, the presence or absence of the voltage drop was measured for 10 batteries for each of Examples and Comparative Example. Thus, the re-contact probability was calculated.

[Peel Strength Test of Intermediate Layer]

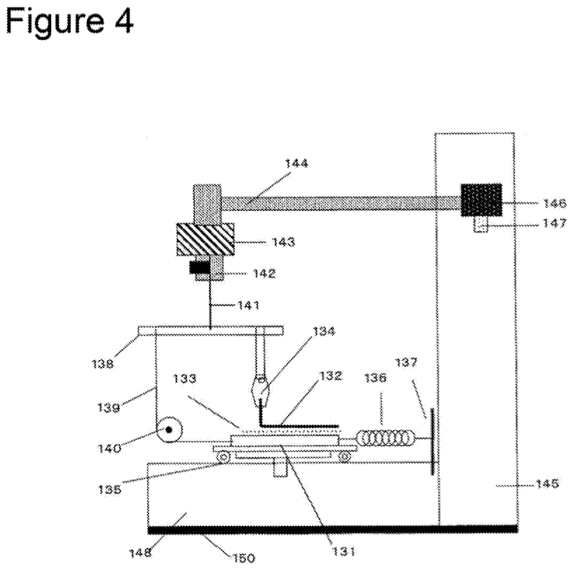

The peel strength of the intermediate layer in the positive electrode used in each of Examples and Comparative Example was measured by using the apparatus shown in FIG. 4. The apparatus shown in FIG. 4 is composed of a base 131 on which a test piece 132 is placed, an adhesive member 133 for fixing the test piece 132, a chuck 134 connected to a pulling base 138 by fixing one end of the test piece 132, a bearing part 135 for horizontally sliding the base 131, a spring 136 that applies a force uniformly when the base 131 slides, a fixed part 137 to which the spring 136 is connected, a pulling base 138 connected to the base 131 via a wire 139 and a pulley 140, a wire 141 for connecting the pulling base 138 and a gripping jig 142, a load cell 143 connected to a gripping jig 142 for detecting the load on the pulling base 138, a support portion 144 for supporting the load cell 143, a drive portion 146 for moving a support portion 144 up and down, a linear sensor 147 for detecting the amount of movement of the gripping jig 142, a support column 145 incorporating the drive portion 146 and the linear sensor 147, and a support base 148 that supports the base 131, and the support base 148 and the support column 145 are fixed to the base 150.

As the test piece 132, a positive electrode cut to a size of 15 mm in length and 120 mm in width was used. The positive electrode (the test piece 132) was fixed to the base 131 with the adhesive member 133, and one end thereof was fixed with the chuck 134. The drive portion 146 was started and the gripping jig 142 was pulled up at a constant rate, thereby pulling the pulling base 138, and accordingly the chuck 134 was pulled up, thereby peeling the intermediate layer from the positive electrode current collector. The stress in this moment was measured with the load cell 143. After the measurement, the pull-up test was performed only with the present measuring test apparatus with the positive electrode removed, and the force component when only the base 131 slides was measured. The force component when only the base 131 slid was subtracted from the stress when the intermediate layer was peeled from the positive electrode current collector to be converted to it per unit length (m), thereby determining the peel strength of the positive electrode mixture layer. The relative ratio of the peel strength of the positive electrode mixture layer in each of Examples when the peel strength of the positive electrode mixture layer in Comparative Example was taken as the reference (1.0) was defined as the peel strength ratio of the positive electrode mixture layer.

Table 1 shows the composition of the intermediate layer of the positive electrode used in each of Examples and Comparative Example, the results of the nailing test (battery temperature and re-contact probability), and the results of the peel strength test of the intermediate layer.

TABLE 1

| | | | | | Battery | | |
|---|---|---|---|---|---|---|---|
| | Intermediate layer | | | | temperature | Peel strength ratio | |
| | | Curing degree of | Conductive | Insulating inorganic | in nailing | of intermediate | Re-contact |
| | Curable resin | cured product | agent | material | test (° C.) | layer | probability (%) |
| Example 1 | Acrylic polymer having | 100% | Acetylene | Aluminum oxide | 30 | 1.5 | 20 |
| | a glycidyl group | | black | | | | |
| Example 2 | Acrylic polymer having | 100% | Acetylene | — | 50 | 1.6 | 30 |
| | a glycidyl group | | black | | | | |
| Example 3 | Acrylic polymer having | 50% | Acetylene | — | 60 | 1.4 | 10 |
| | a glycidyl group | | black | | | | |
| Example 4 | Bisphenol A epoxy | 100% | Acetylene | — | 50 | 1.6 | 20 |
| | resin | | black | | | | |
| Example 5 | Hydroxy group- | 100% | Acetylene | — | 55 | 1.6 | 30 |
| | containing acrylic resin | | black | | | | |
| Example 6 | Carboxyl group- | 100% | Acetylene | — | 60 | 1.4 | 30 |
| | containing acrylic resin | | black | | | | |
| Example 7 | Amino group- | 100% | Acetylene | — | 60 | 1.5 | 20 |
| | containing acrylic resin | | black | | | | |
| Example 8 | Acryloyl group- | 100% | Acetylene | — | 55 | 1.5 | 20 |
| | containing acrylic resin | | black | | | | |
| Example 9 | Methacryloyl group- | 100% | Acetylene | — | 55 | 1.5 | 30 |
| | containing acrylic resin | | black | | | | |
| Comparative | PVDF | — | Acetylene | Aluminum oxide | 70 | 1.0 | 40 |
| Example 1 | | | black | | | | |

The non-aqueous electrolyte secondary battery in each of Examples showed a low battery temperature by the nailing test and a high value of peel strength of the positive electrode mixture layer as compared with the non-aqueous electrolyte secondary battery in Comparative Example. Therefore, in the non-aqueous electrolyte secondary battery, used are the positive electrode comprising the positive electrode current collector, the positive electrode mixture layer, the intermediate layer provided between the above positive electrode current collector and the above positive electrode mixture layer, wherein the above intermediate layer includes the cured product of the curable resin having at least any one of a glycidyl group, a hydroxy group, a carboxyl group, an amino group, an acryloyl group, and a methacryloyl group, and the conductive agent, thereby which can suppress a rise in the battery temperature during internal short circuit. Among Examples, Example 3 in which the cured product included in the intermediate layer was in a semi-cured state exhibited a low value of re-contact probability in the nailing test, as compared with other Examples in which the cured product included in the intermediate layer was in a complete cured state. This is probably because even in the case where the conductive foreign material moves for some reason after an internal short circuit occurred due to the conductive foreign material, the cured product being in a semi-cured state in the intermediate layer flows between the conductive foreign matter and the positive electrode current collector, suppressing re-contact between the conductive foreign matter and the positive electrode current collector.

### REFERENCE SIGNS LIST

10 Secondary battery
11 Positive electrode
12 Negative electrode
13 Separator
14 Electrode assembly
15 Case main body
16 Sealing body
17, 18 Insulating plate
19 Positive electrode lead
20 Negative electrode lead
21 Projecting portion
22 Filter
22a Opening of filter
23 Lower valve body
24 Insulating member
25 Upper valve body
26 Cap
26a Opening of cap
27 Gasket
30 Positive electrode current collector
31 Intermediate layer
32 Positive electrode mixture layer
33 Positive electrode active material particles

1. A secondary battery, comprising:
a positive electrode;
a negative electrode; and
an electrolyte, wherein
the positive electrode comprises:
a positive electrode current collector;
a positive electrode mixture layer including positive electrode active material particles; and
an intermediate layer provided between the positive electrode current collector and the positive electrode mixture layer, and wherein
the intermediate layer comprises:
a cured product of a curable resin having at least any one of a glycidyl group, a hydroxy group, a carboxyl group, an amino group, an acryloyl group, and a methacryloyl group; and
a conductive agent.

2. The secondary battery according to claim 1, wherein at least some of the positive electrode active material particles have at least a part that extends into the intermediate layer.

3. The secondary battery according to claim 1, wherein the curable resin has the carboxyl group.

4. The secondary battery according to claim 1, wherein a thickness of the intermediate layer is 0.1 μm or more and 10 μm or less.

5. The secondary battery according to claim 1, wherein a curing degree of the cured product of the curable resin is 30% or more and 100% or less.

6. The secondary battery according to claim 1, wherein a content of the conductive agent is 1 mass % or more and 100 mass % or less in the cured product.

7. The secondary battery according to claim 1, wherein the intermediate layer includes an insulating inorganic material and a content of the insulating inorganic material is 1 mass % or more and 100 mass % or less in the cured product.

8. The secondary battery according to claim 1, wherein the intermediate layer includes an insulating inorganic material and a sum content of the conductive agent and the insulating inorganic material is 25 mass % or more and 100 mass % or less in the cured product.

9. The secondary battery according to claim 1, wherein the intermediate layer includes an insulating inorganic material and a mass ratio of the insulating inorganic material to the conductive agent is in the range of 1:0.05 to 1:70.

10. The secondary battery according to claim 1, wherein the intermediate layer further includes a fluorine resin and a mass ratio of the curable resin to the fluorine resin is in the range of 1:1 to 1:10.

11. The secondary battery according to claim 1, wherein the conductive agent includes carbon particles.

12. The secondary battery according to claim 1, wherein the positive electrode active material particles includes lithium nickel composite oxide particles.
